(19) United States
(12) Patent Application Publication
(10) Pub. No.: US 2013/0127896 A1
(43) Pub. Date: May 23, 2013

(54) APPARATUS AND METHOD FOR DISPLAYING A LOGO IMAGE IN A MOBILE TERMINAL

(71) Applicant: SAMSUNG ELECTRONICS CO., LTD., Gyeonggi-do (KR)

(72) Inventor: Sang-Min PARK, Seoul (KR)

(73) Assignee: SAMSUNG ELECTRONICS CO., LTD., Gyeonggi-do (KR)

(21) Appl. No.: 13/683,086

(22) Filed: Nov. 21, 2012

(30) Foreign Application Priority Data
Nov. 22, 2011 (KR) 10-2011-0122349

(51) Int. Cl. G09G 5/377; G09G 5/02

(52) U.S. Cl. CPC G09G 5/377; G09G 5/02; G09G 2340/0464; G09G 2340/145
USPC 345/592; 345/635

(57) ABSTRACT

An apparatus and method for displaying a logo image in a mobile terminal includes determining whether a screen displaying a logo image is changed, and if so, an available space in which any image is not displayed is searched according to predetermined criteria for a display of the logo image from a previous screen.

### CLAIM OF PRIORITY

This application claims the benefit under 35 U.S.C. §119(a) of a Korean Patent Application filed in the Korean Intellectual Property Office on Nov. 22, 2011 and assigned Serial No. 10-2011-0122349, the entire disclosure of which is hereby incorporated by reference.

### BACKGROUND OF THE INVENTION

1. Field of the Invention

The present invention relates generally to a mobile terminal, and more particularly, to an apparatus and method for displaying a logo image on a screen of a mobile terminal.

2. Description of the Related Art

In general, logo images identifying a specific product or a service provider are typically provided in a background screen image of mobile terminals.

However, when a user changes the background screen image showing the provider's logo image to another background screen, or another image is placed over the displayed logo image in a next screen, the logo image identifying a particular product or service provider may not be visible on the next screen, thus unable to continuously advertise during different mode of operations.

Therefore, there is a need for a method capable of continuously displaying the logo image to a user even though a current screen is changed by the user.

### SUMMARY OF THE INVENTION

An aspect of exemplary embodiments of the present invention is to provide an apparatus and method for displaying a provider's logo image in a mobile terminal regardless of a change mode of a screen.

In accordance with one aspect of the present invention, an apparatus for displaying a logo image in a mobile terminal includes: a display for displaying a logo image thereon; a memory for storing the logo image; and a controller for determining whether the screen is changed, and if so, searching for an available space in which a specific image is not displayed by analyzing the changed screen according to a predetermined criteria, and if the available space exists, displaying the logo image in the available space.

In accordance with further another aspect of the present invention, a method for displaying a logo image in a mobile terminal includes: determining whether a current screen displaying a logo image is changed; if it is determined that the screen is changed, searching for an available space in which a specific image is not displayed by analyzing the changed screen according to a predetermined criteria; and if the available space exists, displaying the logo image in the available space.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a mobile terminal according to an embodiment of the present invention;

FIG. 2 is a flowchart for displaying a logo image in a mobile terminal according to an embodiment of the present invention;

FIG. 3 is a detailed flowchart for displaying the logo image in the mobile terminal according to an embodiment of the present invention;

FIG. 4 illustrates screens based on arrangement preferences according to an embodiment of the present invention;

FIG. 5 illustrates screens on which a logo image is displayed according to an embodiment of the present invention;

FIG. 6 illustrates a screen on which a logo image is displayed according to another embodiment of the present invention; and

FIG. 7 illustrates screens on which a logo image is displayed according to yet another embodiment of the present invention.

### DETAILED DESCRIPTION OF EXEMPLARY EMBODIMENTS

Exemplary embodiments of the present invention will now be described in detail with reference to the accompanying drawings. Also, descriptions of well-known functions and constructions are omitted for clarity and conciseness.

A mobile terminal, to which exemplary embodiments of the present invention is applicable, may include mobile electronic devices that a user may easily carry with him or her, such as video phones, cell phones, smart phones, International Mobile Telecommunication 2000 (IMT-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, E-Books, portable computers (e.g., notebook computers, tablet computers, etc.), and digital cameras.

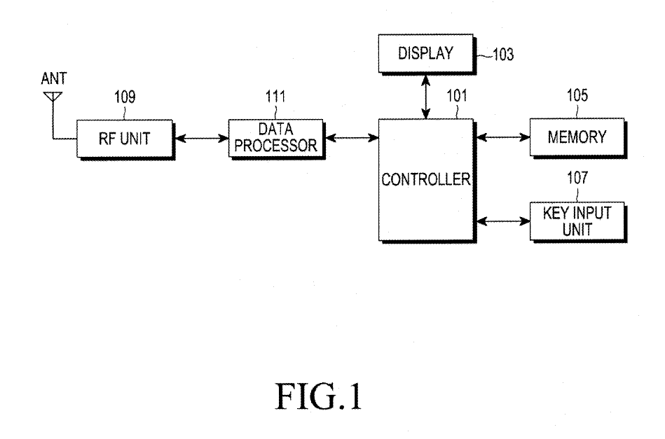

FIG. 1 is a block diagram of a mobile terminal according to an embodiment of the present invention.

Referring to FIG. 1, the mobile terminal includes a controller 101, a display 103, a memory 105, a key input unit 107, a Radio Frequency (RF) unit 109, and a data processor 111.

In operation, the RF unit 109 performs a wireless communication function of the mobile terminal. More specifically, the RF unit 109 includes a wireless transmitter for up-converting a frequency of transmission signals and amplifying the up-converted transmission signals, and a wireless receiver for low-noise-amplifying received signals and down-converting a frequency of the amplified signals. The data processor 111 includes a transmitter for coding and modulating transmission signals, and a receiver for demodulating and decoding received signals.

The key input unit 107 includes alphanumeric keys for inputting alphanumeric and image information as well as function keys for setting various functions. The display 103 displays image signals on its screen, and displays requested data output from the controller 101 on the screen. If the display 103 has a capacitive touch screen or a resistive touch screen, the key input unit 107 may include only a minimum number of predetermined keys, thus the display 103 may partially replace the key input function of the key input unit 107.

The memory 105 includes a program memory and a data memory. The program memory stores booting and Operating System (OS) programs for controlling the general operations of the mobile terminal, and the data memory stores various data generated during an operation of the mobile terminal.

In particular, the memory 105 stores a background screen image displaying a logo image of a particular manufacturer or service provider and stores the logo image, which is extracted by the controller 101 from the background screen image or received from another server or a mobile terminal.

The logo image may be an image of a mobile terminal manufacturer, a communication service provider, a specific product manufacturer, or a specific service provider.

The controller 101 controls the overall operation of the mobile terminal. In particular, when a screen is changed, the controller 101 displays the provider's logo image on the changed screen.

More specifically, the controller 101 receives the background screen displaying the logo image from the memory 105, extracts the logo image from the background screen image, and stores the extracted provider's logo image in the memory 105. Here, the controller 101 may store a size of the logo image together with the logo image. In particular, the controller 101 stores x- and y-axes coordinate values defining the logo image displayed in the background screen.

For example, the background screen may have a format in which the logo image is added to a bitmap type image.

In addition, after the controller 101 displays the background screen image on a screen of the display 103, the controller 101 determines whether the screen is changed. The screen is any one of a standby screen and a main screen, wherein the standby screen is an initial screen displayed on the display 103 when the mobile terminal is turned on, and the main screen is a screen on which icons corresponding to all applications executable in the mobile terminal are listed. The screen change is a case where the background screen image is changed, a case where an icon of a specific application is added to or deleted from the screen, or a case where the provider's logo image is partially viewed due to a screen lock.

If the screen is changed, the controller 101 determines by analyzing the changed screen or next screen to determine whether another image exists in the next screen that may overlaps with a provider's logo image in the previous screen, or whether the provider's logo image exists anywhere in the next screen.

Here, the controller 101 compares the pre-stored x- and y-axes coordinate values of the provider's logo image with x- and y-axes coordinate values of other images in the next screen to see if any of the images overlap with the logo image.

Here, the controller 101 is looking for an available space in the next screen that can display the logo image without overlapping with any images in the next screen. As a comparison result, if any of the x- and y-axes coordinate values of the provider's logo image is not the same as any of the x- and y-axes coordinate values of other images, the controller 101 determines that no other images exist that overlaps with the provider's logo image. Otherwise, if any of the x- and y-axes coordinate values of the provider's logo image is the same as any of the x- and y-axes coordinate values of other images, the controller 101 determines that another image exists which overlaps with the provider's logo image.

If it is determined that another image exists that overlaps with the provider's logo image in the next screen or that the same provider's logo image does not exist on the next screen, the controller 101 determines by analyzing the next screen whether an available space for displaying the provider's logo image exists on the next screen according to a predetermined criteria or a predetermined arrangement preference (explained later).

In this case, the controller 101 checks an available space on a current screen by using codes as shown below:

<appwidget
launcher:packageName=“com.sec.android.widgetapp.stockclock”
launcher:className=“com.sec.android.widgetapp.stockclock.-

StockClock_Integration”

launcher:screen=“2”
launcher:x=“2”
launcher:y=“2”
launcher:spanX=“2”
launcher:spanY=“1” />
<...
xxxxxxx:x=“0”
xxxxxxx:y=“3”
.../>

When icons are arranged on a wallpaper by using x- and y-axes coordinate values and a size of each icon in an Android™ mobile terminal providing an Android™ Operating System (OS), the controller 101 may search for an available space by using the codes as shown above.

The controller 101 determines a size and position of the searched available space and compares the size of the available space with a size of the pre-stored provider's logo image. If the size of the available space is greater than or equal to the size of the pre-stored provider's logo image, the controller 101 displays the provider's logo image in the available space according to a predetermined arrangement preference.

Otherwise, if the size of the available space is less than the size of the pre-stored provider's logo image, the controller 101 generates a new space on the changed screen to display the provider's logo image in the next screen or displays a portion of the provider's logo image on the next screen.

More specifically, the controller 101 determines whether a current screen is a main screen. If the current screen is the main screen, the controller 101 generates a provider's logo icon by generating an icon representative of the provider's logo image having a predetermined icon size to fit in the available space. Note that the logo image may be retrieved from a memory 105 or received from another server or another mobile terminal.

Thereafter, the controller 101 generates a space to arrange the provider's logo icon therein by shifting an icon of a specific application in a predetermined area among a plurality of applications displayed in the next screen by one icon size or space, then displays the provider's logo icon in the generated space.

Since the provider's logo icon is linked to a site associated with a corresponding provider, when the user clicks the provider's logo icon, the controller 101 may communicate with a server of the corresponding provider and display a homepage of the corresponding provider on the display 103.

Otherwise, if the current screen is not the main screen, the controller 101 displays the provider's logo image between application icons. Alternatively, the controller 101 magnifies or up-scales the provider's logo image taking into account a size of the changed screen, makes the magnified provider's logo image semitransparent, and arranges the semitransparent provider's logo image on the changed screen.

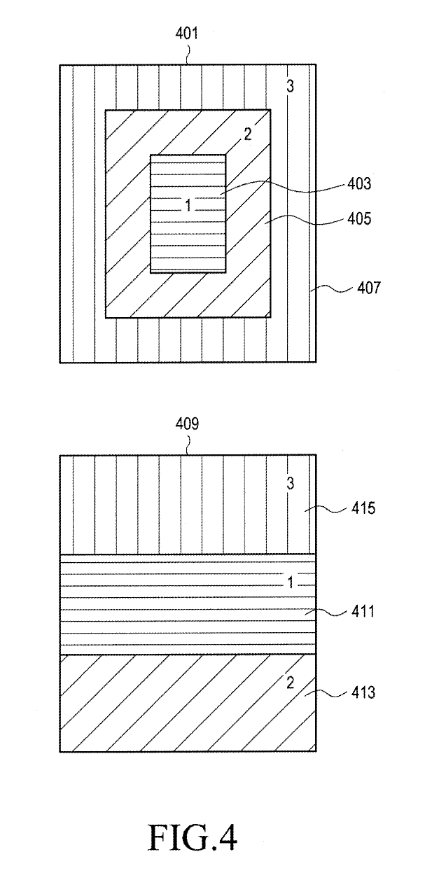

FIG. 4 illustrates first and second screens 401 and 409 based on arrangement preferences according to an embodiment of the present invention.

Referring to FIG. 4, the first screen 401 includes first to third arrangement areas 403, 405, and 407. The logo arrangement preference on the first screen 401 is an order from the first arrangement area 403 to the third arrangement area 407.

For example, if an available space exists in both the third arrangement area 407 and the first arrangement area 403, since the first arrangement area 403 is more preferable as it is more visible than the third arrangement area 407, the controller 101 may arrange the logo image in the available space of the first arrangement area 403.

The second screen 409 includes first to third arrangement areas 411, 413, and 415. The arrangement preference on the second screen 409 is an order from the first arrangement area 411 to the third arrangement area 415.

For example, if an available space exists in both the third arrangement area 415 and the first arrangement area 411, since the first arrangement area 411 has a higher arrangement preference than the third arrangement area 415, the controller 101 may arrange the provider's logo image in the available space of the first arrangement area 411.

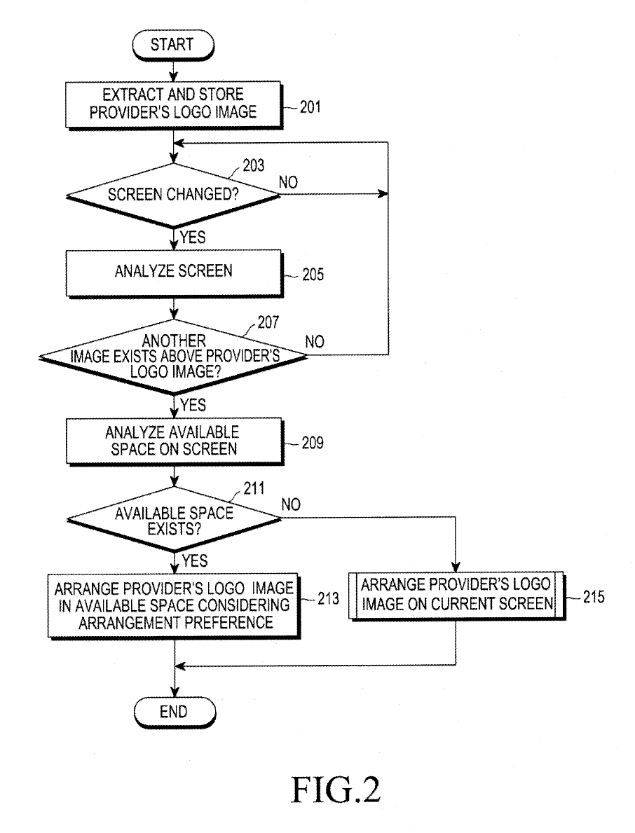

FIG. 2 is a flowchart for displaying a logo image in a mobile terminal according to an embodiment of the present invention.

Referring to FIG. 2, in step 201, the mobile terminal receives a background screen image including a provider's logo image, extracts the provider's logo image from the background screen image, stores the extracted provider's logo image, and proceeds to step 203. Here, the mobile terminal may store information relating to a size of the provider's logo image together with the actual logo image by storing x- and y-axes coordinate values of the provider's logo image included in the background screen image.

For example, the background screen image may have a format in which the provider's logo image is added to a bitmap type image.

In step 203, after the mobile terminal displays the background screen image on a screen, the mobile terminal determines whether the screen is changed. As a result of the determination, if the screen is changed, the mobile terminal proceeds to step 205. Otherwise, the mobile terminal repeatedly performs step 203.

The screen is any one of a standby screen and a main screen, wherein the standby screen is an initial screen displayed when the mobile terminal is turned on, and the main screen is a screen on which icons corresponding to all applications executable in the mobile terminal are listed.

In step 205, the mobile terminal analyzes at least one image included in the changed screen or next screen and proceeds to step 207. In step 207, the mobile terminal determines based on an analysis result whether another image exists in the next screen that overlaps with the provider's logo image. As a result of the determination, if it is determined that another image exists that overlaps with the provider's logo image, the mobile terminal proceeds to step 209. Otherwise, the mobile terminal proceeds back to step 203.

In this case, the mobile terminal compares the pre-stored x- and y-axes coordinate values of the provider's logo image with x- and y-axes coordinate values of other images in the changed screen. As a result of the comparison, if any of the x- and y-axes coordinate values of the provider's logo image is not the same as any of the x- and y-axes coordinate values of other images, the mobile terminal determines that no other images exist that overlaps with the provider's logo image. Otherwise, if any of the x- and y-axes coordinate values of the provider's logo image is the same as any of the x- and y-axes coordinate values of other images, the mobile terminal determines that another image exists above the provider's logo image.

In step 209, the mobile terminal analyzes the changed screen, searches for an available space for arranging the provider's logo image, and proceeds to step 211.

In step 211, the mobile terminal determines whether the available space for arranging the provider's logo image exists on the changed screen. As a result of the determination, if the available space exists on the changed screen, the mobile terminal proceeds to step 213. Otherwise, the mobile terminal proceeds to step 215.

In this case, the mobile terminal compares a size of the searched available space with a size of the pre-stored provider's logo image. If the size of the available space is greater than or equal to the size of the pre-stored provider's logo image, the mobile terminal determines that the available space exists on the changed screen. Otherwise, the mobile terminal determines that no available spaces do not exist on the changed screen.

In step 213, the mobile terminal arranges the provider's logo image in the available space taking into account a pre-defined arrangement preference discussed with reference to FIG. 4

Otherwise, in step 215, the mobile terminal arranges the provider's logo image on the changed screen.

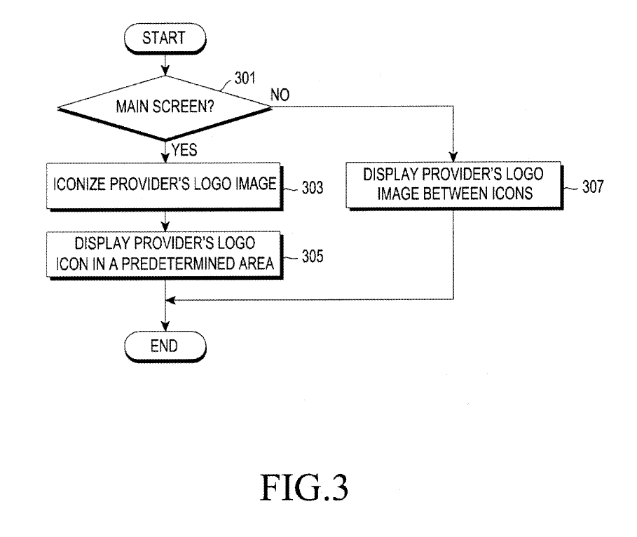

Hereinafter, step 215 is described in more detail with reference to FIG. 3.

In step 301, the mobile terminal determines whether a current screen is the main screen. As a result of the determination, if the current screen is the main screen, the mobile terminal proceeds to step 303. Otherwise, the mobile terminal proceeds to step 307.

In step 303, the mobile terminal generates a provider's logo icon by iconizing the provider's logo image with a predetermined application icon size and proceeds to step 305. Note that the logo image may be retrieved from a memory or received from another server or another mobile terminal.

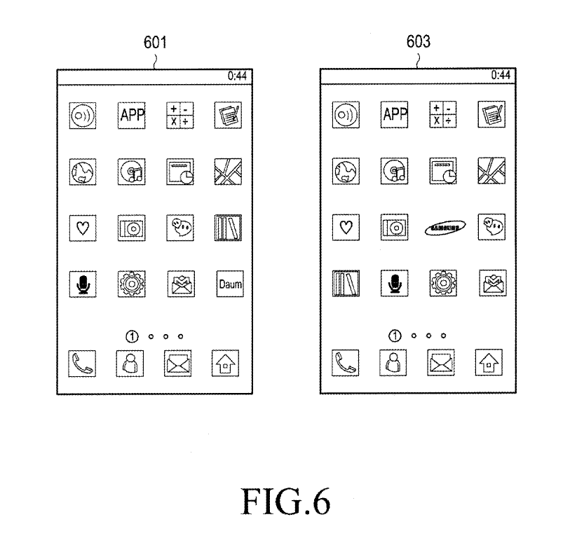

In step 305, the mobile terminal generates a space to arrange the provider's logo icon therein by shifting an icon of a specific application in a predetermined area among a plurality of applications arranged on the changed screen by one icon size and then arranges the provider's logo icon in the generated space (explained later with reference to FIG. 6). Here, the user can specify which icon size to be shifted to accommodate the provider's logo icon.

Note that since the provider's logo icon is linked to a site associated with a corresponding provider, when the user clicks the provider's logo icon, the mobile terminal may communicate with a server of the corresponding provider and display a homepage of the corresponding provider.

If the current screen is not the main screen, in step 307, the mobile terminal arranges a portion of the provider's logo image by using a space between application icons.

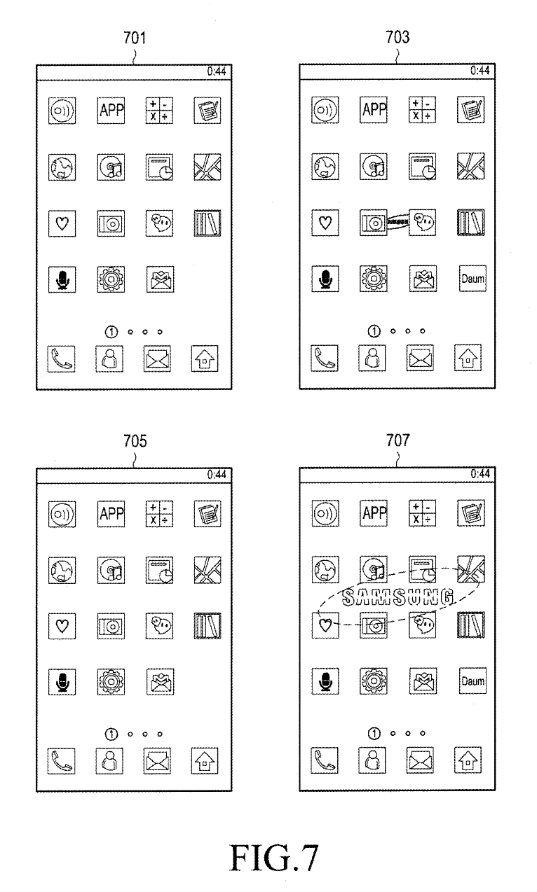

Here, the mobile terminal may display a portion of the provider's logo image by arranging the provider's logo image between existing application icons. To this end, the mobile terminal may display the provider's logo image on the changed screen by controlling the size of the provider's logo image in view of the size of the changed screen through either magnifying or shrinking the logo image selectively, or making the magnified provider's logo image semitransparent and adding the semitransparent provider's logo image to the background screen image. (explained later with reference to FIG. 7). Here, the size of logo image in step 307 can be preset or the user may adjust the size as desired by manipulating the touch screen or input control buttons.

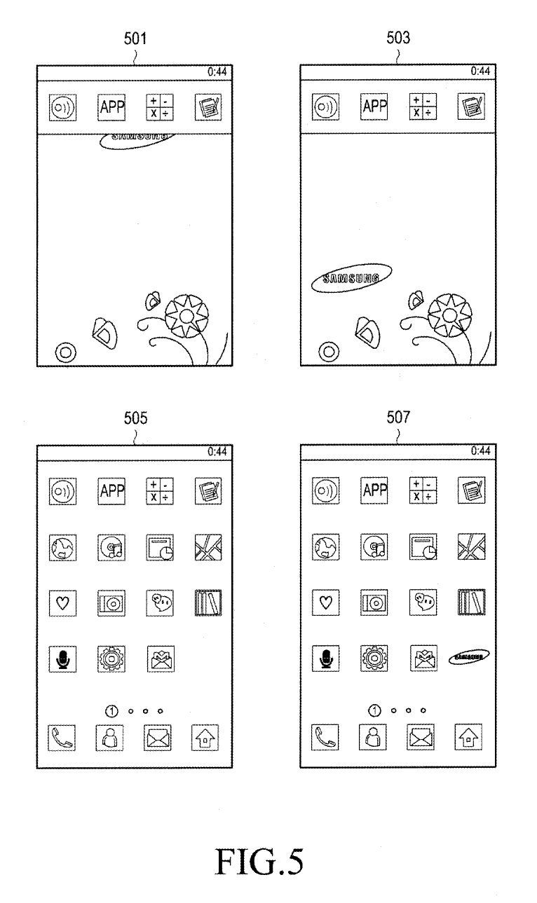

FIG. 5 illustrates screens on which a logo image is displayed according to an embodiment of the present invention.

Referring to FIG. 5, a third screen 501 is a screen on which a provider's logo image and another image overlap with each other, and a fourth screen 503 is a screen on which the provider's logo image is arranged in other available space of the screen according to the teachings of the present invention.

As shown on the third screen 501, if the provider's logo image and another image overlap with each other, a mobile terminal determines a position and size of an available space by analyzing the third screen 501 as explained with reference to FIGS. 2 and 4. Thereafter, the mobile terminal arranges the provider's logo image in the available space taking into account the position and size of the available space, as shown on the fourth screen 503.

As shown, a fifth screen 505 is a screen on which the provider's logo image does not exist, and a sixth screen 507 is a screen on which the provider's logo image is arranged in an available space of the screen.

If the provider's logo image does not exist on the fifth screen 505, the mobile terminal determines a position and size of an available space by analyzing the fifth screen 505. Thereafter, the mobile terminal arranges the provider's logo image in the available space taking into account the position and size of the available space in relation to other icons, as shown on the sixth screen 507.

It should be noted that the embodiments shown in FIG. 5 is for illustrative purposes, thus other combination of preferences or predetermined criteria can be used in selecting an available space of the screen for a display. Accordingly, the examples shown in FIG. 5 should not limit the scope of the invention.

FIG. 6 illustrates a screen on which a logo image is displayed according to another embodiment of the present invention discussed with reference to step 305 of FIG. 3.

Referring to FIG. 6, a seventh screen 601 is a screen on which a provider's logo image does not exist, and an eighth screen 603 is a screen on which the provider's logo image is arranged.

As shown on the seventh screen 601, if the provider's logo image does not exist and a space for arranging the provider's logo image does not exist, the mobile terminal generates a provider's logo icon by iconizing the provider's logo image and generates the space for arranging the provider's logo image by shifting a specific application icon existing in a predetermined area to the right by a predefined icon size. Thereafter, the mobile terminal arranges the provider's logo icon in the generated space, as shown on the eighth screen 603.

FIG. 7 illustrates screens on which a logo image is displayed according to another embodiment of the present invention discussed with reference to step 307 of FIG. 3.

Referring to FIG. 7, a ninth screen 701 is a screen on which a provider's logo image does not exist, and a tenth screen 703 is a screen on which the provider's logo image is arranged.

As shown on the ninth screen 701, if the provider's logo image does not exist and a space for arranging the provider's logo image does not exist, the mobile terminal arranges the provider's logo image between a plurality of application icons, as shown on the tenth screen 703.

An eleventh screen 705 is a screen on which the provider's logo image does not exist, and a twelfth screen 707 is a screen on which the provider's logo image is arranged.

As shown on the eleventh screen 705, if the provider's logo image does not exist and a space for arranging the provider's logo image does not exist, the mobile terminal magnifies the provider's logo image to be less than or equal to the entire screen size and makes the magnified provider's logo image semitransparent. Thereafter, the mobile terminal arranges the semitransparent provider's logo image on the screen, as shown on the twelfth screen 707.

As is apparent from the foregoing description, the present invention may provide an effect that a provider's logo image can be continuously displayed in a mobile terminal regardless of a change of a screen.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for displaying a logo image on a screen of a mobile terminal, comprising:
a display for displaying a logo image thereon;
a memory for storing the logo image; and
a controller for determining whether the screen displaying the logo image is changed, and if so, searching for an available space in a next screen not overlapping with the logo image according to a predetermined criteria and arranging the logo image in the predefined space in the next screen.

2. The apparatus of claim 1, wherein the controller analyzes the next screen to determine a size and position of the available space and compares the determined size with a size of the logo image.

3. The apparatus of claim 2, wherein if the size of the predefined space is greater than or equal to the size of the logo image, the controller displays the logo image in the available space.

4. The apparatus of claim 1, wherein, if the available space does not exist, the controller generates an icon representative of the logo image and inserts the icon on the next screen to an area vacated by shifting a particular application icon among a plurality of application icons displayed in the next screen.

5. The apparatus of claim 1, wherein, if the available space does not exist, the controller displays the logo image between a plurality of application icons displayed in the next screen.

6. The apparatus of claim 1, wherein, if the available space does not exist, the controller magnifies the logo image to be less than or equal to a size of the next screen and displays the magnified logo image on the next screen in a semitransparent format.

7. The apparatus of claim 1, wherein the logo image is one of a manufacturer of the mobile terminal and a service provider.

8. The apparatus of claim 1, wherein, if the available space does not exist, the controller selectively adjusts a size of the logo image for a display on the next screen in a semitransparent format.

9. The apparatus of claim 1, wherein the logo image is received from one of another server or another mobile terminal.

10. The apparatus of claim 1, wherein the logo image is extracted by the controller from the screen and stored in the memory.

11. A method for displaying a logo image on a screen of a mobile terminal, comprising:
determining whether a current screen displaying the logo image is changed;
if it is determined that the screen is changed, searching for an available space according to a predetermined criteria in a next screen to display the logo image; and
if the available space exists, displaying the logo image in the available space.

12. The method of claim 11, wherein the searching comprises:
if the screen is changed, determining whether a specific image in the next screen which overlaps with the logo image in the current screen exists.

13. The method of claim 11, wherein the arranging comprises:
analyzing the next screen to determine a size and position of the available space;
comparing the size of the available space with a size of the logo image displayed in the current screen; and
if the size of the available space is greater than or equal to the size of the logo image, displaying the logo image in the available space in the next screen.

14. The method of claim 11, further comprising:
if the available space does not exist, generating an icon representative of the logo image;
inserting the icon on the next screen to an area vacated by shifting a particular application icon among a plurality of application icons displayed on the next screen.

15. The method of claim 11, further comprising, if the available space does not exist, displaying the logo image between a plurality of application icons displayed on the next screen.

16. The method of claim 11, further comprising:
if the available space does not exist, magnifying the logo image to be less than or equal to a size of the next screen and displaying the magnified logo image in a semitransparent format.

17. The method of claim 11, wherein the logo image is one of a manufacturer of the mobile terminal and a service provider.

18. The method of claim 11, further comprising:
if the available space does not exist, selectively adjusting a size of the logo image for a display on the next screen in a semitransparent format.

19. The method of claim 11, wherein the logo image is extracted from one of another server or another mobile terminal.

20. The method of claim 11, wherein the logo image is extracted from the screen and stored in a memory.
